(19) United States
(12) Patent Application Publication
(10) Pub. No.: US 2002/0125453 A1
(43) Pub. Date: Sep. 12, 2002

(54) Handle drive mechanism for a water control valve

(76) Inventors: Edward R. Donath JR., Westlake, OH (US); Matthew S. McMaster, Medina, OH (US); Davor G. Mandic, Cleveland Heights, OH (US)

Correspondence Address: Daniel C. McEachran, Cook, Alex, McFarron, Manzo, Cummings & Mehler, Suite 2850, 200 West Adams Street, Chicago, IL, 60606, US

(21) Appl. No.: 09/803,515

(22) Filed: Mar. 9, 2001

(51) Int. Cl. F16K 31/60

(52) U.S. Cl. 251/288

(57) ABSTRACT

A handle drive mechanism for use of in operating a water control valve having an outwardly extending valve stem, includes a stem adapter having a bore which is sized and configured to received the stem and to rotate it concurrently with the stem adapter. There is a stop tube extending about the stem and stem adapter with cooperating stop elements on these two members to limit rotation of the stem adapter and valve stem. A handle base extends about and is engaged with the stem adapter and a screw extends through the handle base and stem adapter to attach these elements to the valve stem. A handle cap is attached to the handle base and masks the screw with the handle cap having a plurality of generally centrally positioned inwardly directed flexible hooks which engage with and interlock to the handle base.

### THE FIELD OF INVENTION

The present invention relates to handle drive mechanisms for use in operating water control valves such as shower valves, but may easily be adapted for use in sink mounted faucets. The invention provides a handle base, which may be formed of a transparent or translucent acrylic material and a handle cap which is mounted centrally at the exterior of the handle base. The cap is removably attached to the base and may mask a screw which is used to attach the entire assembly to the control valve operating stem. There is a stem adapter which is attached to the handle base for concurrent rotation and is mounted to the valve stem to provide the drive connection between the handle base and the valve stem. The drive mechanism is simple in construction, reliable, and has an attractive decorative appearance.

### SUMMARY OF THE INVENTION

The present invention relates to a handle drive mechanism for use with a shower control valve and has particular relation to such a mechanism which is reliable in operation and simple in construction.

The primary purpose of the invention is to provide a handle mechanism with a minimum number of parts and in which the attachment of the handle to the valve stem is masked by a removeable handle cap.

Other purposes will appear in the ensuing specifications, drawings and claims.

### BRIEF DESCRIPTION OF THE DRAWINGS

The invention is illustrated diagrammatically in the following drawings wherein:

FIG. 1 is an exploded perspective of the handle drive mechanism and the related shower valve and shower escutcheon;

FIG. 2 is a vertical section through the handle drive mechanism and a portion of the shower valve;

FIG. 3 is a top view of the handle base;

FIG. 4 is a bottom view of the handle base;

FIG. 5 is a section along plane 5-5 of FIG. 3.

FIG. 6 is a partial enlarged section through the handle base with the cap mounted therein;

FIG. 7 is a top view of the stem adapter;

FIG. 8 is a bottom view of the stem adapter;

FIG. 9 is a section along plane 9-9 of FIG. 7;

FIG. 10 is a side view of the handle cap; and

FIG. 11 is a bottom of the handle cap.

### DESCRIPTION OF THE PREFERRED EMBODIMENT

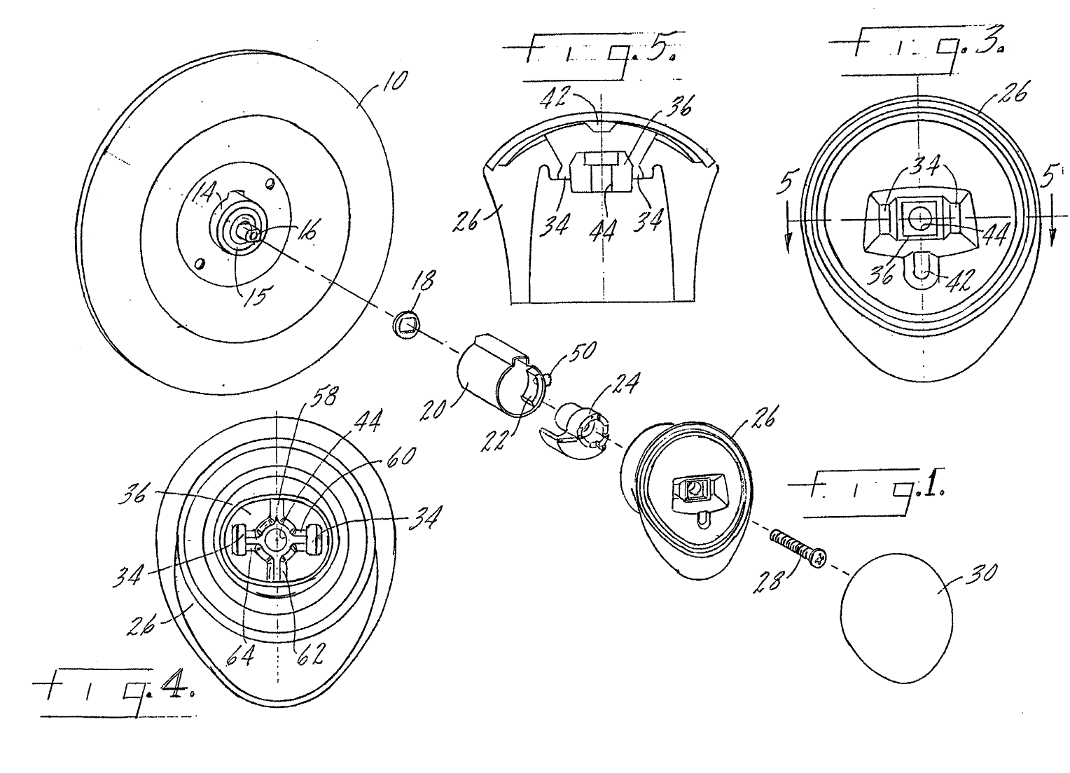

In FIG. 1 the principal elements of the handle drive mechanism are shown in an exploded perspective and include a shower valve escutcheon 10 which will be mounted against the wall of a shower stall shown at 12 in FIG. 2. There is a valve body 14, also shown in FIG. 2, which will mount a shower control valve 15 which may be any one of several types manufactured by Moen, Incorporated, the assignee of the present application. The shower control valve includes an outwardly extending stem 16 which, when rotated, controls the temperature of the water discharged through the showerhead. The drive mechanism shown and described herein is not limited to use as a part of a shower installation and is also applicable to sink mounted faucets.

There is a washer 18 which has an interior double D configuration which matches that of the valve stem 16. A stop tube 20, having an adjustable arcuate stop 22, extends over the projecting portion of the shower valve 15 and contains a portion of a stem adapter 24 when the drive mechanism is fully mounted as shown in FIG. 2. The handle base is indicated at 26 and is attached to the valve stem 16 by means of a screw 28. A handle cap 30 completes the principal components of the handle drive mechanism.

The handle cap 30, as shown in FIGS. 10 and 11, includes a pair of oppositely disposed inwardly directed projections 32 which will interlock with mating recesses 34 formed in a central boss 36 of the handle base 26. These projections are flexible and have outwardly extending hook portions 38 which will extend into the recesses 34 when the cap 30 is snapped into position on the handle base 26. The cap 30 further has an additional projection 40, located generally midway between the projections 32, and which will reside within a recess 42, shown in FIG. 2, when the cap is positioned on the handle base. This insures appropriate alignment of these elements when they are attached.

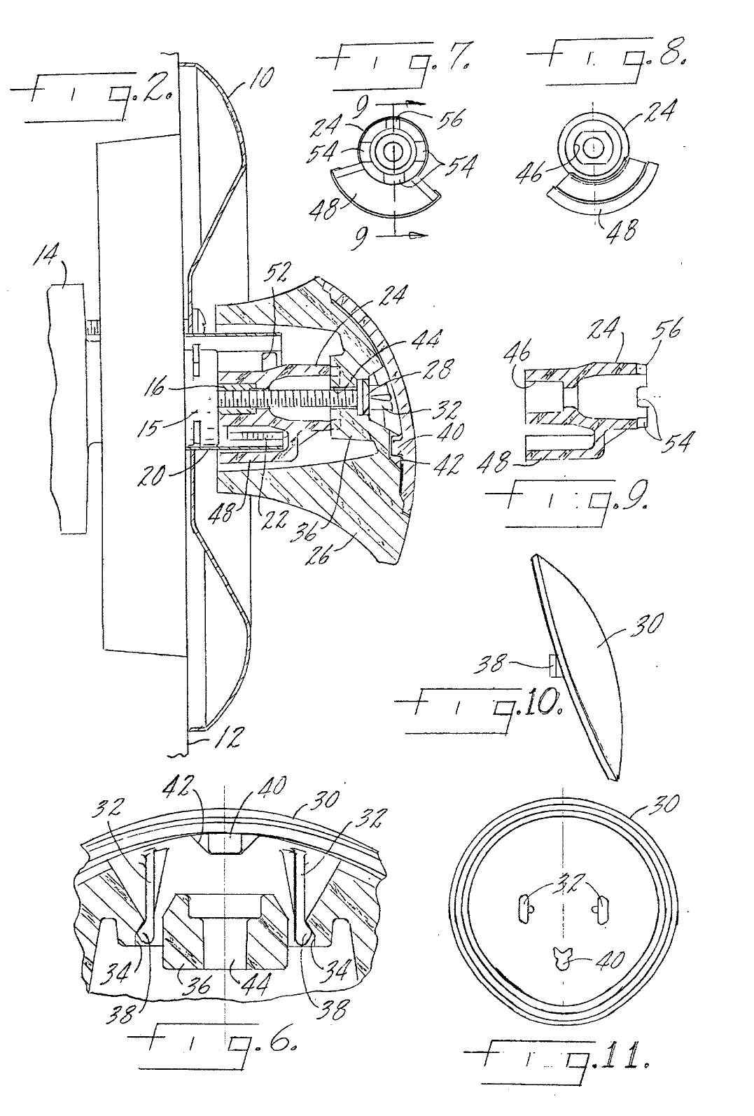

The boss 36, as shown in FIGS. 2 and 6, has a central bore 44 which receives the screw 28, shown principally in FIG. 2, in which the screw is shown attaching all of the elements together and extending into the end of the valve stem 16.

The stem adapter 24, shown in FIGS. 7, 8 and 9, includes a bore 46 which has the same double D size and configuration as the exterior of the stem 16 and the interior of washer 18. Thus the stem 16 will extend within the bore 46, as clearly shown in FIG. 2, when the drive mechanism is mounted to the water control valve. The stem adapter 24 also has a projection 48 of limited arcuate extent as shown particularly in FIGS. 7 and 8, which interacts with the adjustable stop 22 on the stop tube 20 to limit rotation of the drive mechanism. The stop 22 includes in the wall of the stop tube, a screw 50, as shown in FIG. 1, which permits stop adjustment through a slot 52 as shown in FIG. 2. A change in the circumferential position of the arcuate stop 22 allows for adjustment of the degree of handle rotation when operating the shower valve.

The stem adapter 24 further has, at its outward end, a series of four slots 54, shown in FIG. 9 and FIG. 7, three of which are of equal size and the fourth indicated at 56, being somewhat smaller in width. The four slots interact and interlock with four ribs on the handle base shown in FIG. 4. The ribs are indicated at 58, 60, 62 and 64, with the ribs 60, 62 and 64 being of equal size and the rib 58 being of a somewhat smaller size. The nonuniform sized slots receive the ribs 58-64 and assure appropriate alignment between the stem adapter and handle base so that these two elements are properly oriented in installation. The handle base can only be assembled on the stem adapter in one position because of the differential in size between the slots 54, 56 and the ribs 58-64.

In assembly of the handle drive mechanism, after the escutcheon 10 has been appropriately mounted to the wall 12 and the shower control valve 15 with its stem 16 protrude through the escutcheon, first the washer 18 is mounted on the stem, followed by appropriate location of the stop 20. The stem adapter is engaged with the handle base and then these two elements are attached by the screw 28 to the valve stem 16. The handle cap may then be snapped on the handle base to complete the installation.

Of importance in the invention is the unique location of the flexible projections 32 which mount the cap 30 to the base 26. The cap 30 masks the screw 28 so that it is not visible and also makes the cap projections located adjacent to the center of the handle base, rather than at the periphery of the base as was common in prior art configurations. Further masking of the screw is important in that often the handle base may be a translucent or transparent acrylic material and it is not desirable from an acetic point of view to have the mounting screw visible to the user of the product.

The drive mechanism is reliable, and simple in construction in that there are appropriate alignment and locating means on all of the interlocking parts.

Whereas the preferred form of the invention has been shown and described herein, it should be realized that there may be many modifications, substitutions and alterations thereto.

The embodiment of the invention in which an exclusive property or privilege is claimed are defined as follows:

1. A handle drive mechanism for use in operating a water control valve, which valve has an outwardly extending valve stem. Said drive mechanism including a stem adapter having a bore therein which is sized and configured to receive said stem and to rotate said stem concurrently with stem adapter rotation,
a stop tube extending about said stem and stem adapter, cooperating means on said stem adapter and stop tube for limiting rotation of said stem adapter,
a handle base extending about and engaged with said stem adapter, a threaded member attaching said handle base and stem adapter to said stem,
a handle cap attached to said handle base and overlying said threaded member, said handle cap having a plurality of generally centrally positioned inwardly directed flexible attaching members which engage with recess means on said handle base.

2. The handle drive mechanism of claim 1 wherein said flexible attaching members have lateral projections at their inward ends which extend said recess means.

3. The handle drive mechanism of claim 2 wherein there are two diametrically opposed attaching members.

4. The handle drive mechanism of claim 3 further including a projection on said handle cap, generally intermediate said flexible attaching members, and a mating recess for said projection on said handle base.

5. The handle drive mechanism of claim 1 wherein said stem adapter includes an arcuate project located within said stop tube, and an arcuate stop on the inside of said stop tube, said projection and stop limiting rotation of said handle base and stem adapter.

6. The handle drive mechanism of claim 5 wherein the arcuate position of the arcuate stop on said stop tube is adjustable.

7. The handle drive mechanism of claim 1 wherein said stem adapter includes a plurality of outwardly directed slots, said handle base having a plurality of ribs formed and adapted to mate with said stem adapter slots for concurrent rotation of said elements.

8. The handle drive mechanism of claim 7 wherein said outwardly extending slots on the stem adapter are of nonuniform size to provide alignment means for said handle base on said stem adapter.

9. The handle drive mechanism of claim 1 wherein said handle base includes a generally central chamber, said stem adapter and stop tube extending within said chamber, said handle base having a generally central boss which extends into said chamber and provides the means for attaching said handle base to said stem adapter for concurrent rotation.

10. The handle drive mechanism of claim 9 wherein said threaded member extends through said handle base boss, said handle base boss having a plurality of ribs which cooperate outwardly extending slots on said stem adapter for locking said elements together for concurrent rotation.
